(19) United States
(12) Patent Application Publication
(10) Pub. No.: US 2014/0168216 A1
(43) Pub. Date: Jun. 19, 2014

(54) 3D AVATAR OUTPUT DEVICE AND METHOD

(71) Applicant: Electronics and Telecommunications Research Institute, Daejeon (KR)

(72) Inventors: Kap Kee KIM, Daejeon (KR); Bon Woo HWANG, Daejeon (KR); Seung Uk YOON, Bucheon-si (KR); Seong Jae LIM, Daejeon (KR); Hye Ryeong JUN, Daejeon (KR); Jin Sung CHOI, Daejeon (KR); Bon Ki KOO, Daejeon (KR)

(73) Assignee: Electronics and Telecommunications Research Institute, Daejeon (KR)

(21) Appl. No.: 14/102,783

(22) Filed: Dec. 11, 2013

(30) Foreign Application Priority Data
Dec. 14, 2012 (KR) 10-2012-0146287

(51) Int. Cl. G06T 17/00

(52) U.S. Cl. CPC G06T 17/00
USPC 345/420

(57) ABSTRACT

A 3D avatar output device and method are disclosed. The 3D avatar output device of a vending machine type may include an input data receiving unit to receive input data including at least one of user information, a 3D avatar theme, and a 3D avatar output form; an image obtaining unit to obtain an image of a user through a camera included in the 3D avatar output device; a restoration model generation unit to generate a restoration model by extracting a facial area from the obtained image; a unique model generation unit to generate a unique model of the user based on the input data and the restoration model; and a 3D avatar output unit to generate a 3D avatar corresponding to the unique model and output the 3D avatar according to the 3D avatar output form.

### CROSS-REFERENCE TO RELATED APPLICATION

This application claims the benefit of Korean Patent Application No. 10-2012-0146287, filed on Dec. 14, 2012, in the Korean Intellectual Property Office, the disclosure of which is incorporated herein by reference.

### BACKGROUND

1. Field

The present invention relates to an avatar output device and method, and more particularly, to a 3-dimensional (3D) avatar output device and method of a vending machine type, which obtain an image of a user and generate a 3D avatar according to a theme and output type desired by the user based on the obtained image.

2. Description of Related Art

A conventional 3-dimensional (3D) avatar generation device obtains an image of a user from a camera, and generates a 3D avatar of the user based on the obtained image. However, according to the conventional 3D avatar generation device, once a 3D avatar is generated, it is difficult to change an appearance of the 3D avatar. Furthermore, the conventional 3D avatar generation device requires a long time to generate the 3D avatar.

In addition, a conventional sticker photo taking device outputs a 2-dimensional (2D) photo. The sticker photo taking device operates in a vending machine type. Although the sticker photo taking device takes a relatively short time to output the 2D photo, utilization efficiency of the 2D photo is relatively low.

Accordingly, there is a desire for a 3D avatar generation device capable of minimizing 3D avatar generation time and variously changing an appearance of the 3D avatar, using an interface of a vending machine type.

### SUMMARY

An aspect of the present invention provides a 3-dimensional (3D) avatar output device and method, capable of easily outputting a 3D avatar of a user without requiring much time, by outputting the 3D avatar in a vending machine type.

Another aspect of the present invention provides a 3D avatar output device and method of a vending machine type, capable of reproducing a user desired theme in real time, by applying various themes desired by the user to the 3D avatar.

Still another aspect of the present invention provides a 3D avatar output device and method of a vending machine type, capable of providing a user with a user desired output, by outputting the 3D avatar according to a user desired output form.

According to an aspect of the present invention, there is provided a 3D avatar output device of a vending machine type, the 3D avatar output device including an input data receiving unit to receive input data including at least one of user information, a 3D avatar theme, and a 3D avatar output form, an image obtaining unit to obtain an image of a user through a camera included in the 3D avatar output device, a restoration model generation unit to generate a restoration model by extracting a facial area from the obtained image, a unique model generation unit to generate a unique model of the user based on the input data and the restoration model, and a 3D avatar output unit to generate a 3D avatar corresponding to the unique model and output the 3D avatar according to the 3D avatar output form.

The input data receiving unit may receive at least one input data among a gender, an age, and a skin color of the user.

The input information receiving unit may receive the 3D avatar theme predetermined and provided by the 3D avatar output device.

The input data receiving unit may receive at least one 3D avatar output form among a hologram photo, a 3D figure, a movie clip, and 3D file format data, from the user.

The restoration model generation unit may extract the facial area of the image using background modeling or 3D face model information.

The unique model generation unit may process at least one service scenario among a predetermined standard model, a 3D background, an accessory, and a motion animation, corresponding to the 3D avatar theme.

The unique model generation unit may attach a face portion of the restoration model to a face of the standard model.

The unique model generation unit may extract feature points of the restoration model using texture information and 3D geometry information of the restoration model.

The unique model generation unit may extract texture information of the restoration model input to a location corresponding to a texture map of a standard model predetermined corresponding to the 3D avatar theme.

The unique model generation unit may generate the unique model using the feature points and texture information of the restoration model.

According to another aspect of the present invention, there is provided a 3D avatar output method of a vending machine type, the 3D avatar output method including receiving input data including at least one of user information, a 3D avatar theme, and a 3D avatar output form, obtaining an image of a user through a camera included in the 3D avatar output device, generating a restoration model by extracting a facial area from the obtained image, generating a unique model of the user based on the input data and the restoration model, and generating a 3D avatar corresponding to the unique model and outputting the 3D avatar according to the 3D avatar output form.

The receiving may include receiving at least one input data among a gender, an age, and a skin color of the user.

The receiving may include receiving the 3D avatar theme predetermined and provided by the 3D avatar output device.

The receiving may include receiving at least one 3D avatar output form among a hologram photo, a 3D figure, a movie clip, and 3D file format data, from the user.

The generating of the restoration model may include extracting the facial area of the image using background modeling or 3D face model information.

The generating of the unique model may include processing at least one service scenario among a predetermined standard model, a 3D background, an accessory, and a motion animation, corresponding to the 3D avatar theme.

The generating of the unique model may include attaching a face portion of the restoration model to a face of the standard model.

The generating of the unique model may include extracting feature points of the restoration model using texture information and 3D geometry information of the restoration model.

The generating of the unique model may include extracting texture information of the restoration model input to a location corresponding to a texture map of a standard model.

The generating of the unique model may include generating the unique model using the feature points and texture information of the restoration model.

### EFFECT

According to embodiments of the present invention, a 3-dimensional (3D) avatar output device and method may conveniently output a 3D avatar of a user without requiring much time, by outputting the 3D avatar in a vending machine type.

Additionally, according to embodiments of the present invention, a 3D avatar output device and method of a vending machine type may reproduce a user desired theme in real time, by applying various themes desired by the user to the 3D avatar.

Additionally, according to embodiments of the present invention, a 3D avatar output device and method of a vending machine type may provide the user with a user desired output, by outputting the 3D avatar according to a user desired output form.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a 3-dimensional (3D) avatar output device according to an embodiment of the present invention;

FIG. 2 is a diagram illustrating a detailed configuration of a 3D avatar output device, according to an embodiment of the present invention;

FIG. 3 is a diagram illustrating an operational flow of a 3D avatar output device, according to an embodiment of the present invention;

FIG. 4 is a diagram illustrating a functional configuration of a 3D avatar output device, according to an embodiment of the present invention; and

FIG. 5 is a diagram illustrating a 3D avatar output method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

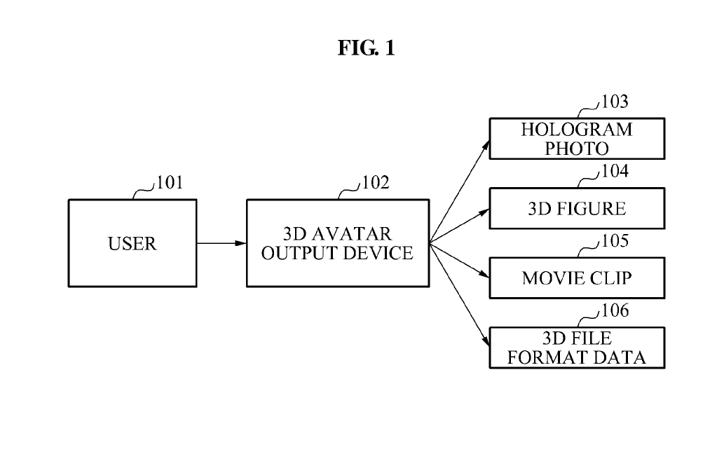

FIG. 1 is a diagram illustrating a 3-dimensional (3D) avatar output device 102 according to an embodiment of the present invention.

Referring to FIG. 1, the 3D avatar output device 102 may be in a vending machine type. That is, the 3D avatar output device 102 may generate a 3D avatar of a user in the vending machine type. By outputting the 3D avatar in the vending machine type, the 3D avatar output device 102 may output the 3D avatar of the user conveniently without requiring much time.

The 3D avatar output device 102 may receive input data related to generation of the 3D avatar, from a user 101. Here, the user 101 may input the input data by touching the 3D avatar output device 102.

The input data may include user information of the user 101, a 3D avatar theme, and a 3D avatar output form. The user information may include basic information such as a gender and an age, skin color information, and the like. The 3D avatar theme may include various themes provided by the 3D avatar output device 102. For example, the 3D avatar theme may be applied to a background and an environment of the 3D avatar. That is, the 3D avatar output device 102 may provide a ‘cosmos theme’ among the themes of the 3D avatar. In this case, the 3D avatar output device 102 may provide the user with a 3D avatar wearing a ‘space suit’ with a ‘cosmos’ background corresponding to the ‘cosmos’ theme.

A 3D avatar theme type may be an output of a user desired type.

The 3D avatar output device 102 may obtain an image of the user using a camera included in the 3D avatar output device 102. For example, the 3D avatar output device 102 may obtain the image using a camera having an image quality equivalent to or higher than an image quality of a webcam, and a depth camera. In addition, the 3D avatar output device 102 may include at least two cameras. The 3D avatar output device 102 may include at least one depth camera. The 3D avatar output device 102 may generate a restoration model corresponding to a facial area of the image, using the obtained image of the user. The restoration model may be obtained by extracting an appearance of the user from the image of the user. That is, the restoration model may include facial structures such as eyes, a noise, and a mouth, and positions of spots or scars.

The 3D avatar output device 102 may generate a unique model of the user, based on the input data including the user information, the 3D avatar theme, and the 3D avatar output form, and the restoration model. The unique model may refer to a final model of the user, generated based on an appearance of the restoration model, and texture information and feature points according to the restoration model. The 3D avatar output device 102 may generate the 3D avatar using the unique model. In addition, the 3D avatar output device 102 may output the 3D avatar according tohe 3D avatar output form desired by the user.

In detail, the 3D avatar output device 102 may generate the 3D avatar of the user, according to the 3D avatar output form such as a hologram photo 103, a 3D FIG. 104, a movie clip 105, and 3D file format data 106. Here, the 3D file format data 106 may be data reproducible by a user terminal. For example, the 3D file format data 106 may be reproduced by the user terminal such as an iPAD, a desktop, a tablet PC, and the like.

The 3D avatar output device 102 may reproduce a user desired theme in real time, by applying various themes desired by the user by operating in the vending machine type. In addition, since the 3D avatar output device 102 outputs the 3D avatar according to the 3D avatar output form desired by the user, by operating in the vending machine type, thereby providing the user with a user desired output.

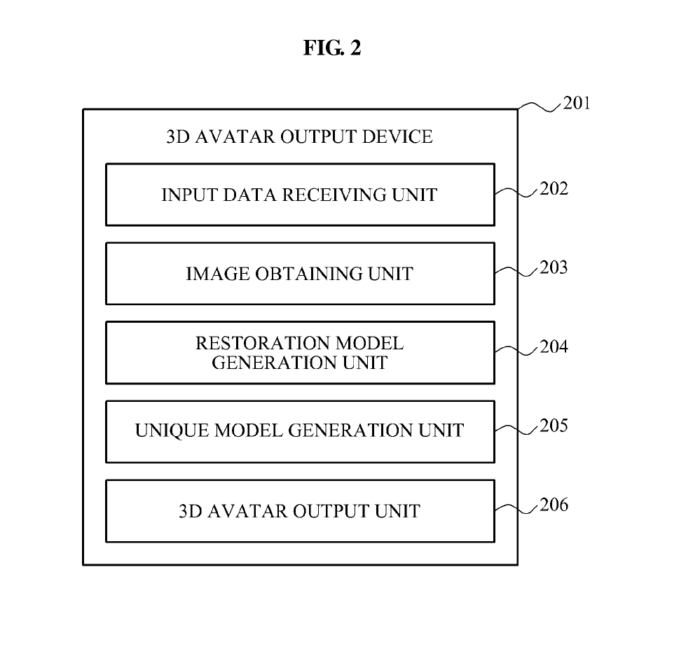

FIG. 2 is a diagram illustrating a detailed configuration of a 3D avatar output device 201, according to an embodiment of the present invention.

Referring to FIG. 2, the 3D avatar output device 201 may include an input data receiving unit 202, an image obtaining unit 203, a restoration model generation unit 204, a unique model generator 205, and a 3D avatar output unit 206.

The input data receiving unit 202 may receive input data including at least one of user information, a 3D avatar theme, and a 3D avatar output form. The user information may include basic information such as a gender and an age, skin color information, and the like. The user information may be used for generating a 3D avatar similar to an appearance of the user. In addition, the user information, as base information for generation of the 3D avatar, may be used for service control and registration control.

The 3D avatar theme may be predetermined in the 3D avatar output device 201. In addition, the 3D avatar theme may include various themes selectable by the user. The 3D avatar theme may be selected by the user. Also, the 3D avatar theme, as base information for generation of the 3D avatar, may be used for the service control corresponding to a user desired theme.

The 3D avatar output form may be an output result desired by the user in the 3D avatar output device 201 of a vending machine type. Here, a plurality of 3D avatar output forms may be selected. The 3D avatar output form may include a hologram photo, a 3D figure, a movie clip, 3D file format data, and the like.

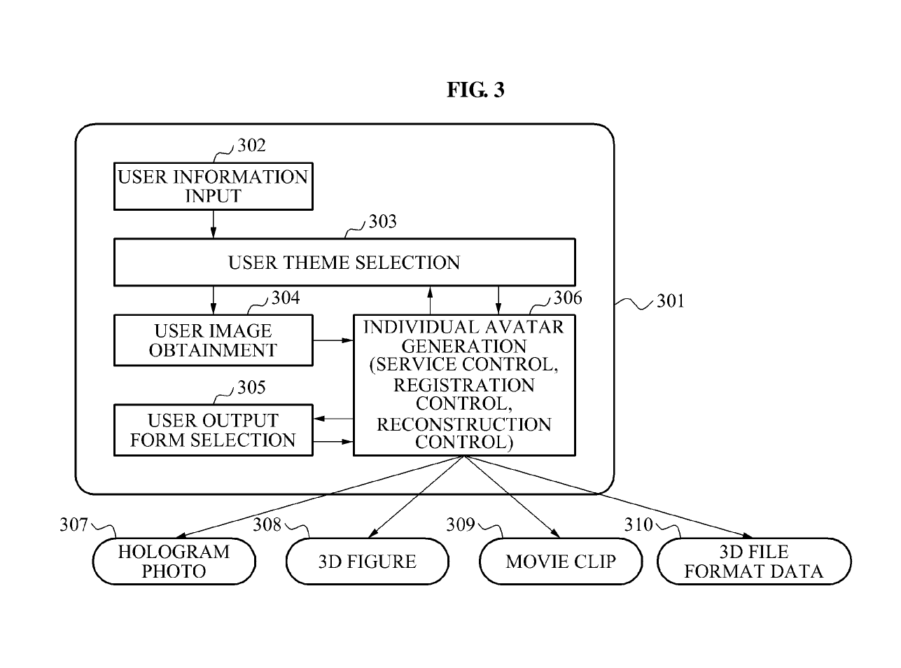

The input data receiving unit 202 may receive the input data including at least one of the user information, the 3D avatar theme, and the 3D avatar output form, sequentially. That is, the input data receiving unit 202 may receive the input data sequentially according to an operational flow of the 3D avatar output device 201 of the vending machine type. The foregoing operation will be described in detail with reference to FIG. 3.

The image obtaining unit 203 may obtain an image of the user through a camera included in the 3D avatar output device 201. Here, the image obtaining unit 203 may obtain the image of the user, using at least two cameras having an image quality equivalent to or higher than an image quality of a webcam, and at least one depth camera. A number of the cameras is not limited to the foregoing description. A plurality of cameras may be used to obtain the image of the user. The obtained image may be used as base data for generation of the 3D avatar. Here, the image obtaining unit 203 may obtain a 2D image corresponding to the at least two 2D images, a 3D depth map, and a depth map.

The restoration model generation unit 204 may generate a restoration model corresponding to a facial area of the obtained image. That is, the restoration model generation unit 204 may extract the facial area from the obtained image. For example, when the image for extracting the facial area is obtained from a stereo camera, the restoration model generation unit 204 may continuously use a foreground extraction algorithm and a skin extraction algorithm through background modeling, thereby extracting the facial area. As another example, when the image for extracting the facial area is obtained from a depth camera, the restoration model generation unit 204 may extract the facial area through depth information and texture information input using 3D face model information.

The restoration model generation unit 204 may generate the restoration model corresponding to the facial area of the extracted image. In addition, the restoration model generation unit 204 may generate the restoration model corresponding to the facial area of the image using the background modeling or the 3D face model information.

The unique model generation unit 205 may generate a unique model based on the input data and the restoration model. That is, the unique model generation unit 205 may use the user information, the 3D avatar theme, and the restoration model, which are received by an input data receiving unit. The unique model generation unit 205 may process a service scenario in units of a user. The user unit may refer to different users using the 3D avatar output device 201 of the vending machine type. That is, the user unit may refer to an individual user using the 3D avatar output device 201.

Additionally, the unique model generation unit 205 may process at least one service scenario among a predetermined standard model, a 3D background, an accessory, and a motion animation. The standard model may include a common standard model according to the 3D avatar theme. In addition, the standard model may be a standard model predetermined by the 3D avatar output device 201.

The unique model generation unit 205 may attach a face portion of the restoration model to a face of the standard model. The unique model generation unit 205 may render the standard model by a 3D scene using a predetermined 3D background and accessory. Here, the unique model generation unit 205 may render the rendered standard model with two images of a particular angle of view of the 3D scene.

The unique model generation unit 205 may include the motion animation of the standard model set for every predetermined theme. In addition, the unique model generation unit 205 may render an image using the motion animation, thereby encoding the rendered image to video. Furthermore, the unique model generation unit 205 may control entire service scenario of the 3D avatar output device 201 based on a user selection.

The unique model generation unit 205 may extract feature points of the restoration model using the texture information and 3D geometry information of the restoration model. The texture information of the restoration model may be texture information of a restoration model located corresponding to the feature points defined by the standard model. In addition, the unique model generation unit 205 may reflect the feature points of the restoration model to the 3D geometry information. The unique model generation unit 205 may extract the texture information of the restoration model input to a location corresponding to the texture information of the standard model. In addition, the unique model generation unit 205 may accord the texture information of the extracted restoration model to the texture information of the standard model. That is, the unique model generation unit 205 may accord texture color tones related to the texture information of the restoration model and the texture information of the standard model.

The unique model generation unit 205 may generate the unique model using the feature points of the restoration model and the texture information. For example, when the unique model is generated using a stereo camera, the unique model generation unit 205 may extract five points related to the feature points using the texture information and the 3D geometry information. In addition, using the extracted five feature points, the unique model generation unit 205 may transit the standard model to the unique model, thereby generating the unique model. As another example, when the unique model is generated using a depth camera, the unique model generation unit 205 may generate the unique model using the feature points obtained during extraction of the facial area of the image.

Here, the 3D avatar output device 201 may apply the generated unique model to various themes. In detail, the 3D avatar output device 201 may easily apply an initially generated unique model to all themes without a dedicated work, by applying a same standard model to all themes.

The 3D avatar output unit 206 may generate the 3D avatar of the user corresponding to the generated unique model, and may output the 3D avatar according to the 3D avatar output form. In addition, the 3D avatar output unit 206 may output a plurality of output materials according to the 3D avatar output form. The output material may refer to a result of outputting the 3D avatar. For example, the 3D avatar output unit 206 may output the 3D avatar including a hologram photo, a 3D figure, a movie clip, 3D file format data, and the like.

The 3D avatar output device 201, being in a vending machine type, may use a touch input method convenient for the user. In addition, the 3D avatar output device 201 may minimize time required for generation of the 3D avatar, using an automated scenario according to predetermined themes. That is, the 3D avatar output device 201 may reduce output time of the 3D avatar using the touch type interface and the automated scenario.

In addition, the 3D avatar output device 201 may output various types of output material using the initially generated 3D avatar of the user. Also, the 3D avatar output device 201 may output the various output materials according to the various themes predetermined in the 3D avatar output device 201.

FIG. 3 is a diagram illustrating an operational flow of a 3D avatar output device 301, according to an embodiment of the present invention.

Referring to FIG. 3, the operational flow of the 3D avatar output device 301 may include user information input 302, user theme selection 303, user image obtainment 304, user output form selection 305, and individual avatar generation 306.

The user information input 302 may correspond to the input data receiving unit 202 of FIG. 2. The user information input 302 may receive input data. The input data may include a gender, an age, a skin color, and the like of the user. In the user information input 302, information for using the 3D avatar output device 301 may be input by the user. For example, the 3D avatar output device 301 may process preparation for generation of the 3D avatar by receiving the input data of the user from the user. That is, the 3D avatar output device 301 may start the operational flow for generating the 3D avatar by receiving the input data.

The user theme selection 303 may correspond to the input data receiving unit 202 of FIG. 2. The user theme selection 303 may include various themes provided by the 3D avatar output device 301 of the vending machine type. In the user theme selection 303, a theme provided by the user may be selected. Here, the user may select a desired theme.

The user image obtainment 304 may correspond to the image obtaining unit 203 of FIG. 2. The user image obtainment 304 may obtain the image of the user through a camera included in the 3D avatar output device 301. In detail, the user image obtainment 304 may obtain the image of the user using a camera having an image quality equivalent to or higher than an image quality of a webcam and a depth camera. The obtained image may be used as basic data for generation of the 3D avatar.

The user output type selection 305 may correspond to the input data receiving unit 202 of FIG. 2. In the user output type selection 305, a 3D avatar output form desired by the user may be selected by the user. Here, a plurality of 3D avatar output forms may be selected as desired by the user.

The individual avatar generation 306 may correspond to the restoration model generation unit 204, the unique model generation unit 205, and the 3D avatar output unit 206 of FIG. 2. The individual avatar generation 306 may generate an individual avatar through processes of service control, registration control, and reconstruction control. In addition, the individual avatar generation 306 may generate the individual avatar based on the user theme selection 303 and the user image obtainment 304. That is, the individual avatar generation 306 may generate a 3D individual avatar using an input image. For example, the individual avatar generation 306 may generate the 3D individual avatar using at least two 2D images, a 3D map, and a 2D image corresponding to the 3D depth map.

In addition, the individual avatar generation 306 may generate the 3D avatar in the form of a hologram photo 307, a 3D FIG. 308, a movie clip 309, and 3D file format data, according to the user output form selection 305 selected by the user. Here, the output form is not limited to the foregoing examples. The 3D avatar may be output in various other forms.

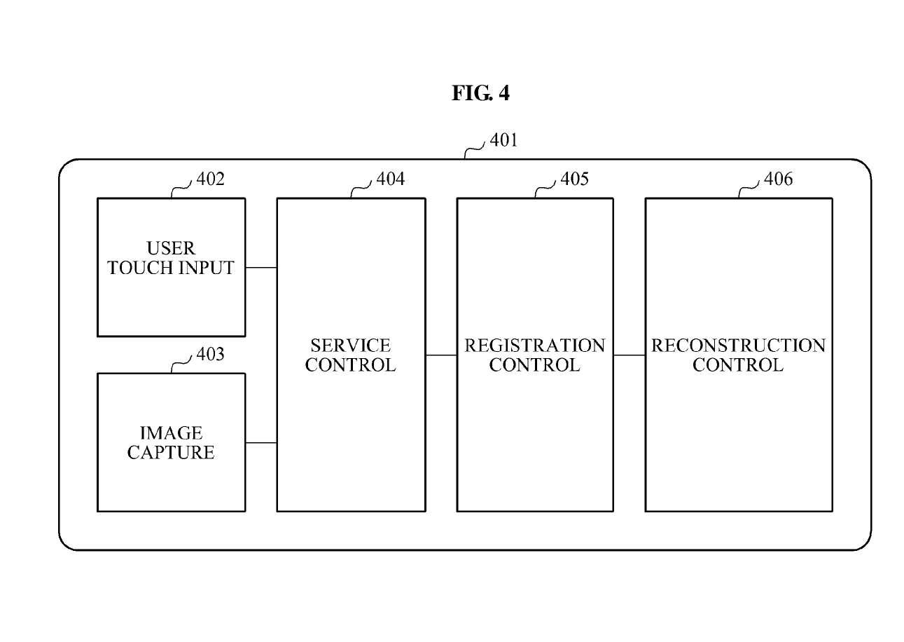

FIG. 4 is a diagram illustrating a functional configuration of a 3D avatar output device 401, according to an embodiment of the present invention.

Referring to FIG. 4, the functional configuration of the 3D avatar output device 401 may include user touch input 402, image capture 403, service control 404, registration control 405, and restoration control 406.

The user touch input 402 may correspond to the user information input 302, the user theme selection 303, and the user output form selection 305 of FIG. 3. That is, the user touch input 402 may be a function for processing input data input by the user in the 3D avatar output device 401 of a vending machine type.

The user touch input 402 may process the input data input by the user. The user touch input 402 may receive the input data including at least one of user information, a 3D avatar theme, and a 3D avatar output form. In addition, the user touch input 402 may receive the input data sequentially.

The image capture 403 may correspond to the user image obtainment 304 of FIG. 3. The image capture 403 may capture an image of the user through a camera included in the 3D avatar output device 401. Here, the image capture 403 may obtain at least two 2D images, a 3D map, and a 2D image corresponding to the 3D depth map. The image capture 403 may be a function for obtaining the image of the user.

The service control 404 may correspond to the individual avatar generation 306 of FIG. 3. The service control 404 may be a function for processing a service scenario in units of a user. The service control 404 may include a 3D printer exporting function, a lenticular printer exporting function, a user terminal (iPAD) exporting function, a clip exporting function, and a scenario processing function.

In detail, the 3D printer exporting function refers to formats that may be processed by a 3D printer, including stereolithography (STL), filmbox (FBX), and the like. The 3D printer exporting function may print only a face of a restored image for quick 3D printing and attach the face to a pre-manufactured standard theme. Here, the standard theme may include a predetermined face and body.

The lenticular printer exporting function may store an input of a lenticular printer in the standard theme to a multi picture object (MPO) format. The lenticular printer exporting function may render a pre-manufactured 3D background and accessory to two images of a particular angle of view of a 3D scene.

The user terminal exporting function may refer to a pre-manufactured unique model and may be an object (OBJ) format.

The clip exporting function may provide a motion animation of a model set for each theme and render each image, thereby encoding the rendered image to video.

The scenario processing function may control entire scenario included in the 3D avatar output device 401. In addition, the scenario processing function may control a service scenario of the entire 3D avatar output device 401 according to a user selection.

The registration control 405 may correspond to the individual avatar generation 306 of FIG. 3. The registration control 405 may generate a unique model using a restoration model and a standard model. The restoration model may be a result of restoring an obtained image corresponding to a facial area. The standard model may be a 3D model to be referenced. An appearance of the unique model may be similar to an appearance of the user, reflecting the restoration model. The standard model may be a common standard model set for all themes provided by the 3D avatar output device 401 of a vending machine type.

In addition, the registration control 405 may include a geometry registration function and a texture processing function. The geometry registration function may extract feature points of the restoration model using texture information and 3D geometry information of the restoration model. The texture information of the restoration model may correspond to feature points defined for the standard model. The geometry registration function may reflect the feature points of the restoration model as the 3D geometry information of the standard model.

The texture processing function may extract texture information of the restoration input to a location corresponding to a texture map of the standard model. The texture processing function may accord the texture information of the restoration model to the texture information of the standard model. That is, the texture processing function may accord texture color tones of the texture information of the restoration model and the texture information of the standard model.

The restoration control 406 may correspond to the individual avatar generation of FIG. 3. The restoration control 406 may refer to a function of generating a 3D restored appearance from an input image. The restoration control 406 may generate the 3D restored appearance using the geometry information and the texture information.

The restoration control 406 may include a rectification function, a segmentation function, a stereo smoothing function, a view reconstruction function, and a surface smoothing function. The restoration control 406 may a depth post-processing function and a surface post-processing function.

When the image is input from a stereo camera, the restoration control 406 may generate the restoration model using the rectification function, the segmentation function, and the stereo smoothing function. The restoration control 406 may generate the restoration model using the depth post-processing function and the surface post-processing function when depth information and a texture image is input from a depth camera.

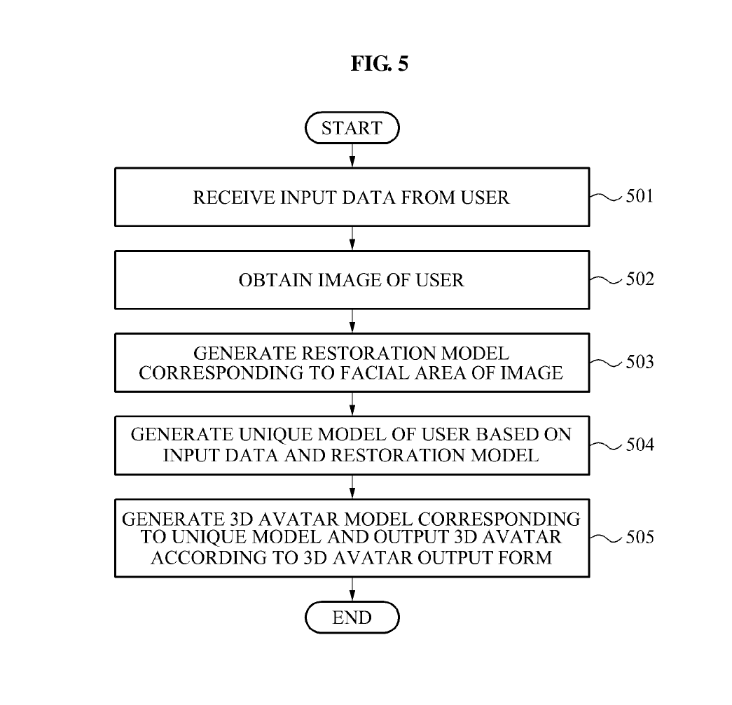

FIG. 5 is a diagram illustrating a 3D avatar output method according to an embodiment of the present invention.

In operation 501, the 3D avatar output device may receive input data from the user. The input data may include at least one of user information, a 3D avatar theme, and a 3D avatar output form. The user information may include basic information such as a gender and an age, skin color information, and the like. The 3D avatar theme may include various themes predetermined in the 3D avatar output device. The 3D avatar output form may be an output result desired by the user in the 3D avatar output device of a vending machine type. Here, a plurality of 3D avatar output forms may be selected.

In operation 502, the 3D avatar output device may obtain an image of the user, thereby generating a restoration model corresponding to a facial area of the image. The 3D avatar output device may obtain the image of the user using at least two stereo cameras and at least one depth camera included in the 3D avatar output device.

In operation 503, the 3D avatar output device may extract the facial area of the obtained image. Here, the 3D avatar output device may extract the facial area using background modeling and 3D face model information. When the image is obtained by the stereo camera, the 3D avatar output device may extract the face image through the background modeling. When the image is obtained by the depth camera, the 3D avatar output device may extract the face image through depth information and texture information. In addition, the restoration model may be generated corresponding to the facial area of the extracted image. The restoration model may be a result of 3D restoration.

In operation 504, the 3D avatar output device may generate a unique model of the user based on the 3D avatar theme of the input data and the restoration model. In addition, the 3D avatar output device may process a service scenario in units of a user. The service scenario may include at least one of a predetermined standard model, a 3D background, an accessory, and a motion animation corresponding to the 3D avatar theme. The 3D avatar output device may extract feature points of the restoration model using texture information and 3D avatar geometry information of the restoration model. The 3D avatar output device may reflect the extracted feature points of the restoration model as 3D geometry information of the standard model. The 3D avatar output device may extract the texture information of the restoration model input to a location corresponding to texture information of the standard model, and accord texture color tones of the texture information of the restoration model and the texture information of the standard model.

In operation 505, the 3D avatar output device may generate the 3D avatar of the user corresponding to the unique model being generated. In addition, the 3D avatar output device may output the 3D avatar according to a 3D avatar output form. In detail, the 3D avatar output device may output the 3D avatar in the form of a hologram photo, a 3D figure, a movie clip, and 3D file format data, according to the 3D avatar output form.

The 3D avatar output device being in a vending machine type may set a 3D avatar body and accessory in advance according to the output form and the theme. In addition, by outputting the facial area of the restoration model, the 3D avatar output device may reduce time required for generating the 3D avatar.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A 3D avatar output device of a vending machine type, the 3D avatar output device comprising:
an input data receiving unit to receive input data including at least one of user information, a 3D avatar theme, and a 3D avatar output form;
an image obtaining unit to obtain an image of a user through a camera included in the 3D avatar output device;
a restoration model generation unit to generate a restoration model by extracting a facial area from the obtained image;
a unique model generation unit to generate a unique model of the user based on the input data and the restoration model; and
a 3D avatar output unit to generate a 3D avatar corresponding to the unique model and output the 3D avatar according to the 3D avatar output form.

2. The 3D avatar output device of claim 1, wherein the input data receiving unit receives at least one input data among a gender, an age, and a skin color of the user.

3. The 3D avatar output device of claim 1, wherein the input information receiving unit receives the 3D avatar theme predetermined and provided by the 3D avatar output device.

4. The 3D avatar output device of claim 1, wherein the input data receiving unit receives at least one 3D avatar output form among a hologram photo, a 3D figure, a movie clip, and 3D file format data, from the user.

5. The 3D avatar output device of claim 1, wherein the restoration model generation unit extracts the facial area of the image using background modeling or 3D face model information.

6. The 3D avatar output device of claim 1, wherein the unique model generation unit processes at least one service scenario among a predetermined standard model, a 3D background, an accessory, and a motion animation, corresponding to the 3D avatar theme.

7. The 3D avatar output device of claim 6, wherein the unique model generation unit attaches a face portion of the restoration model to a face of the standard model.

8. The 3D avatar output device of claim 1, wherein the unique model generation unit extracts feature points of the restoration model using texture information and 3D geometry information of the restoration model.

9. The 3D avatar output device of claim 1, wherein the unique model generation unit extracts texture information of the restoration model input to a location corresponding to a texture map of a standard model predetermined corresponding to the 3D avatar theme.

10. The 3D avatar output device of claim 8, wherein the unique model generation unit generates the unique model using the feature points and texture information of the restoration model.

11. A 3D avatar output method of a vending machine type, the 3D avatar output method comprising:
receiving input data including at least one of user information, a 3D avatar theme, and a 3D avatar output form;
obtaining an image of a user through a camera included in the 3D avatar output device;
generating a restoration model by extracting a facial area from the obtained image;
generating a unique model of the user based on the input data and the restoration model; and
generating a 3D avatar corresponding to the unique model and outputting the 3D avatar according to the 3D avatar output form.

12. The 3D avatar output method of claim 11, wherein the receiving comprises receiving at least one input data among a gender, an age, and a skin color of the user.

13. The 3D avatar output method of claim 11, wherein the receiving comprises receiving the 3D avatar theme predetermined and provided by the 3D avatar output device.

14. The 3D avatar output method of claim 11, wherein the receiving comprises receiving at least one 3D avatar output form among a hologram photo, a 3D figure, a movie clip, and 3D file format data, from the user.

15. The 3D avatar output method of claim 11, wherein the generating of the restoration model comprises extracting the facial area of the image using background modeling or 3D face model information.

16. The 3D avatar output method of claim 11, wherein the generating of the unique model comprises processing at least one service scenario among a predetermined standard model, a 3D background, an accessory, and a motion animation, corresponding to the 3D avatar theme.

17. The 3D avatar output method of claim 16, wherein the generating of the unique model comprises attaching a face portion of the restoration model to a face of the standard model.

18. The 3D avatar output method of claim 11, wherein the generating of the unique model comprises extracting feature points of the restoration model using texture information and 3D geometry information of the restoration model.

19. The 3D avatar output method of claim 11, wherein the generating of the unique model comprises extracting texture information of the restoration model input to a location corresponding to a texture map of a standard model.

20. The 3D avatar output method of claim 18, wherein the generating of the unique model comprises generating the unique model using the feature points and texture information of the restoration model.
